(19) United States
(12) Patent Application Publication
(10) Pub. No.: US 2015/0002341 A1
(43) Pub. Date: Jan. 1, 2015

(54) RADIATOR FRAME HAVING ANTENNA PATTERN EMBEDDED THEREIN, ANTENNA PATTERN FRAME INCLUDING RADIATOR FRAME, AND ELECTRONIC DEVICE INCLUDING ANTENNA PATTERN FRAME

(71) Applicant: SAMSUNG ELECTRO-MECHANICS CO., LTD., Suwon (KR)

(72) Inventors: Sung Eun CHO, Suwon (KR); Hyeon Gil . NAM, Suwon (KR); Dae Kyu . LEE, Suwon (KR); Nam Ki . KIM, Suwon (KR); Dae Seong JEON, Suwon (KR); Dae Ki . LIM, Suwon (KR); Hyun Do PARK, Suwon (KR); Sang Woo . BAE, Suwon (KR); Ha Ryong HONG, Suwon (KR); Chan Gwang Gwang AN, Suwon (KR)

(73) Assignee: SAMSUNG ELECTRO-MECHANICS CO., LTD., Suwon (KR)

(21) Appl. No.: 14/029,458

(22) Filed: Sep. 17, 2013

(30) Foreign Application Priority Data
Jun. 28, 2013 (KR) 10-2013-0076013

(51) Int. Cl. H01Q 1/24

(52) U.S. Cl. CPC H01Q 1/243
USPC 343/702

(57) ABSTRACT

There are provided a radiator frame having an antenna pattern embedded therein, an antenna pattern frame including the radiator frame, and an electronic device including the antenna pattern frame. The radiator frame includes: a radiator including an antenna pattern part transmitting or receiving a signal and a connection terminal part electrically connecting the antenna pattern part and a circuit board to each other; and a molding frame formed by injection-molding the radiator so that the antenna pattern part is exposed to one surface and the connection terminal part is exposed to the other surface, a surface opposite to the one surface, wherein the antenna pattern part includes one or more spikes molded in and fixed to the molding frame, and the molding frame includes one or more connection part trace grooves formed from end portions of one or more spikes toward an edge of the molding frame.

### CROSS-REFERENCE TO RELATED APPLICATIONS

This application claims the priority of Korean Patent Application No. 10-2013-0076013 filed on Jun. 28, 2013, in the Korean Intellectual Property Office, the disclosure of which is incorporated herein by reference.

### BACKGROUND OF THE INVENTION

1. Field of the Invention

The present invention relates to a radiator frame having an antenna pattern embedded therein, an antenna pattern frame including the radiator frame, and an electronic device including the antenna pattern frame.

2. Description of the Related Art

Mobile communications terminals such as cellular phones, personal digital assistants (PDAs), navigation devices, laptop computers, and the like, supporting wireless communications, are necessities in modern society. Such mobile communications terminals have been developed to used with communications schemes such as code division multiple access (CDMA), wireless local area networks (WLAN), global system for mobile communications (GSM), digital multimedia broadcasting (DMB), or the like. One of the most important components that enables these functions is an antenna.

An antenna used in mobile communications terminals has evolved from an exterior type antenna, such as a rod antenna or a helical antenna, to an interior type antenna disposed within the terminal.

The exterior type antenna may be vulnerable to external impacts, while the interior type antenna may increase a volume of a terminal in which it is disposed.

In order to solve these problems, research into technology for integrating antennas into the mobile communications terminals has been actively conducted.

According to the related art, a scheme of injection-molding a radiator to form a radiator frame and directly utilizing the radiator frame or repeatedly injection-molding the radiator frame to allow the radiator to be embedded in an antenna pattern frame or a case of an electronic device has been used.

Meanwhile, in the case in which one or more radiators are injection-molded in an array type scheme, each radiator is provided with an array frame connected to each radiator and is connected to the array frame by a connection part.

However, since the connection part is connected to an antenna pattern part of the radiator, when the radiator is injection-molded to manufacture the radiator frame, a trace of the connection part is exposed to an upper surface of the radiator frame, that is, a portion at which the antenna pattern part is exposed.

In this case, even in the case that the radiator frame is installed in the case of an electronic device, a trace of the connection part may be exposed to the outside of the case which may mar an appearance of an exterior of such an electronic device.

### SUMMARY OF THE INVENTION

An aspect of the present invention provides a radiator frame in which a trace of a connection part is not generated on a surface.

That is, the present invention allows a surface on which the radiator frame is exposed to the outside to generally have a smooth shape in consideration of the fact that an exterior design of the radiator frame is very important, since the radiator frame may be directly mounted in an electronic device.

According to an aspect of the present invention, there is provided a radiator frame including: a radiator including an antenna pattern part transmitting or receiving a signal and a connection terminal part electrically connecting the antenna pattern part and a circuit board to each other; and a molding frame formed by injection-molding the radiator so that the antenna pattern part is exposed to one surface and the connection terminal part is exposed to the other surface, a surface opposite to the one surface, wherein the antenna pattern part includes one or more spikes molded in and fixed to the molding frame, and the molding frame includes one or more connection part trace grooves formed from end portions of one or more spikes toward an edge of the molding frame.

One or more spikes may be disposed along an edge of the antenna pattern part at predetermined intervals.

The connection part trace groove may be formed in the other surface of the molding frame.

The end portion of one or more spike may be exposed through the connection part trace groove toward the other surface of the molding frame.

According to another aspect of the present invention, there is provided an electronic device including: an electronic device case; the radiator frame as described above mounted in the electronic device case; and a circuit board electrically connected to the connection terminal part to receive the signal from the radiator or transmit the signal to the radiator.

According to another aspect of the present invention, there is provided an antenna pattern frame including: a radiator frame including a radiator having an antenna pattern part transmitting or receiving a signal and a connection terminal part electrically connecting the antenna pattern part and a circuit board to each other and a molding frame formed by injection-molding the radiator so that the antenna pattern part is exposed to one surface and the connection terminal part is exposed to the other surface, a surface opposite to the one surface; and a cover frame injection-molded so as to cover one surface of the radiator frame to allow the antenna pattern part to be embedded between the cover frame and the radiator frame, wherein the antenna pattern part includes one or more spikes molded in and fixed to the molding frame, and the molding frame includes one or more connection part trace grooves formed from end portions of one or more spikes toward an edge of the molding frame.

One or more spikes may be disposed along an edge of the antenna pattern part at predetermined intervals.

The connection part trace groove may be formed in the other surface of the molding frame.

According to another aspect of the present invention, there is provided an electronic device including: an electronic device case; the antenna pattern frame as described above mounted in the electronic device case; and a circuit board electrically connected to the connection terminal part to receive the signal from the radiator or transmit the signal to the radiator.

According to another aspect of the present invention, there is provided an electronic device case including: a radiator frame including a radiator having an antenna pattern part transmitting or receiving a signal and a connection terminal part electrically connecting the antenna pattern part and a circuit board to each other and a molding frame formed by injection-molding the radiator so that the antenna pattern part is exposed to one surface and the connection terminal part is exposed to the other surface, a surface opposite to the one surface; and a case frame injection-molded so as to cover one surface of the radiator frame to allow the antenna pattern part to be embedded between the cover frame and the radiator frame and forming an exterior of an electronic device, wherein the antenna pattern part includes one or more spikes molded in and fixed to the molding frame, and the molding frame includes one or more connection part trace grooves formed from end portions of one or more spikes toward an edge of the molding frame.

According to another aspect of the present invention, there is provided an electronic device including: the electronic device case as described above; and a circuit board electrically connected to the connection terminal part to receive the signal from the radiator or transmit the signal to the radiator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a state in which a radiator frame is coupled to a case of a mobile communications terminal, which is an electronic device according to an embodiment of the present invention;

FIG. 2 is a schematic exploded perspective view illustrating a form of a mobile communications terminal manufactured using the radiator frame according to the embodiment of the present invention;

FIG. 3 is a schematic perspective view illustrating a radiator provided in the radiator frame according to the embodiment of the present invention;

FIG. 4 is a schematic perspective view of the radiator frame according to the embodiment of the present invention;

FIG. 5 is a schematic cross-sectional view taken along line A-A′ of FIG. 4;

FIG. 6 is a schematic perspective view illustrating a state in which an antenna pattern frame is coupled to a case of a mobile communications terminal, an electronic device according to another embodiment of the present invention, wherein the antenna pattern frame is shown in a form of a partially cut-away schematic perspective view;

FIG. 7 is a schematic exploded perspective view illustrating a form of a mobile communications terminal manufactured using the antenna pattern frame according to another embodiment of the present invention;

FIG. 8 is a schematic cross-sectional view of the antenna pattern frame having an antenna radiator embedded therein according to another embodiment of the present invention, taken along line A-A′ of FIG. 4;

FIG. 9 is a schematic perspective view illustrating a state in which an antenna pattern frame is molded in a case of a mobile communications terminal, an electronic device according to another embodiment of the present invention, wherein the antenna pattern frame is shown in a form of a partially cut-away schematic perspective view of the case; and

FIGS. 10 through 13 are views illustrating a process of manufacturing a radiator frame using an antenna array according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

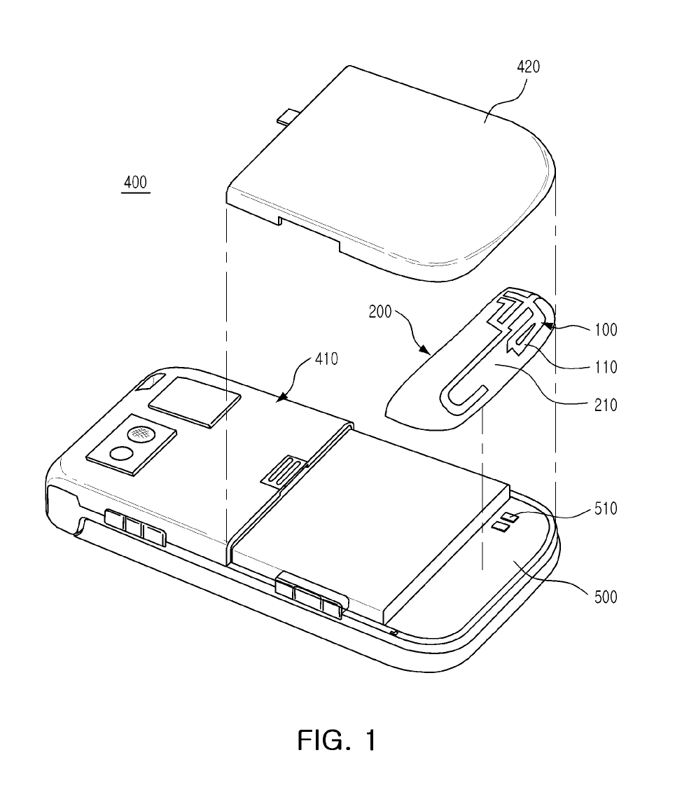

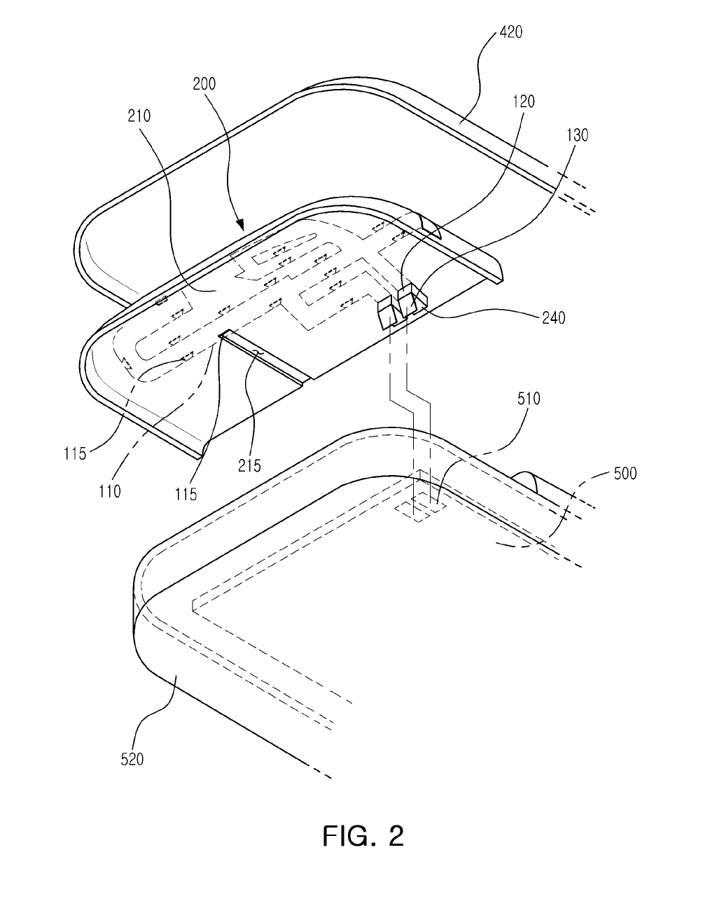

FIG. 1 is a schematic perspective view illustrating a state in which a radiator frame is coupled to a case of a mobile communications terminal, an electronic device according to an embodiment of the present invention; and FIG. 2 is a schematic exploded perspective view illustrating a form of a mobile communications terminal manufactured using the radiator frame according to the embodiment of the present invention.

Referring to FIGS. 1 and 2, the mobile communications terminal 400, the electronic device according to an embodiment of the present invention, may include a case 410 forming an exterior thereof and a battery cover 420 covering a battery mounting part and a radiator frame 200. The radiator frame 200 may include an antenna pattern part 110 embedded in a molding frame 210. In addition, the antenna pattern part 110 may include one or more spikes (fixed protrusion member protruding toward the radiator frame) 115 protruding toward the other surface along an edge thereof and molded in the molding frame 210. The spike 115 may prevent a radiator 100 from being separated from the radiator frame 200 in the case in which the radiator 100 is molded in and fixed to the radiator frame 200.

In addition, the molding frame 210 may include one or more connection part trace grooves 215 formed from end portions of one or more spikes 115 toward an edge of the molding frame 210. The connection part trace groove 215 may correspond to a trace that may be formed on a surface of the radiator frame 200, more specifically, the molding frame 210, in a process of simultaneously manufacturing one or more radiator frames 200 using an array type (meaning a radiator type in which one or more antenna radiators 100 are put and molded in a mold, respectively, and are connected to each other, such that one or more radiator frames 200 in which the antenna radiator 100 is molded may be simultaneously manufactured by one process) of antenna radiator.

That is, in the case in which one or more radiators 100 are injection-molded in the array type, each radiator 100 may be provided with an array frame 160 connected to each radiator and be connected to the array frame 160 by a frame connection part 150 extended from an end portion of the spike 115. Therefore, the frame connection part 150 may be inevitably injection-molded together with the radiator 100 in a process of injection-molding the radiator 100. When the frame connection part 150 is removed after the injection-molding is finished, the connection part trace groove 215 extended from the end portion of the spike 115 toward the edge of the molding frame 210 may be formed in the surface of the radiator frame 200, more specifically, the molding frame 210. Meanwhile, the connection part trace groove 215 may be extended from the end portion of the spike 115 and be formed in the other surface, a surface opposite to one surface on which the radiator 110 is exposed. In other words, the frame connection part 150 may be injection-molded so as to be exposed along the other surface of the radiator frame 200, more specifically, the molding frame 210. When the end portion of the spike 115 is cut and the frame connection part 150 is removed after the injection-molding is finished, the connection part trace groove 215 may be formed in the other surface of the radiator frame 200, more specifically, the molding frame 210. Therefore, the end portion of one or more spike 115 may be exposed toward the other surface of the radiator frame 200, more specifically, the molding frame 210 through the connection part trace groove 215.

Here, the radiator 100 may include a connection terminal part 130 for connection to a terminal 510 of a circuit board 500, and the connection terminal part 130 is connected to the terminal 510 of the circuit board 500, whereby the radiator frame 200 mounted in the mobile communications terminal 400 may implement antenna performance in the mobile communications terminal 400.

Here, the connection terminal part 130 may elastically contact the terminal 510 in order to secure reliability of connection with the terminal 510.

Meanwhile, in the case in which the antenna pattern part 110 is mounted in the electronic device such as the mobile communications terminal 400, or the like, when the antenna pattern part 110 is not covered by the battery cover 420, it may be exposed to the outside. In this case, since the connection part trace groove 215 of the radiator frame 200 is formed in the other surface of the radiator frame 200, one surface exposed in the radiator frame 200 may have a smooth shape. In addition, the antenna pattern part 110 and the molding frame 210 on one surface of the radiator frame 200 on which the antenna pattern part 110 is exposed may be provided with a protective film (not shown).

That is, the radiator frame 200 may be mounted in the electronic device such as the mobile communications terminal 400, or the like. In this case, an outer surface of the radiator frame 200 may be additionally covered with a film, or the like. More specifically, one surface of the radiator frame 200 on which the antenna pattern part 110 is exposed to the outside may be additionally covered with the film, or the like. In the case in which the radiator frame 200 is covered by the battery cover 420, since the radiator frame 200 is not exposed to the outside, a problem is not generated. However, in the case in which the battery cover 420 is opened in order to replace a battery, or the like, since the radiator frame 200 is exposed to the outside. Therefore, the reason why one surface of the radiator frame 200 on which the antenna pattern part 110 is exposed to the outside is additionally covered with the film is to consider an exterior design in the case in which in the case in which the battery cover 420 is opened. For example, the film may be immediately formed by spraying a liquid by painting, or the like, or be simply formed by attaching manufactured goods such as a film, a coating, or the like.

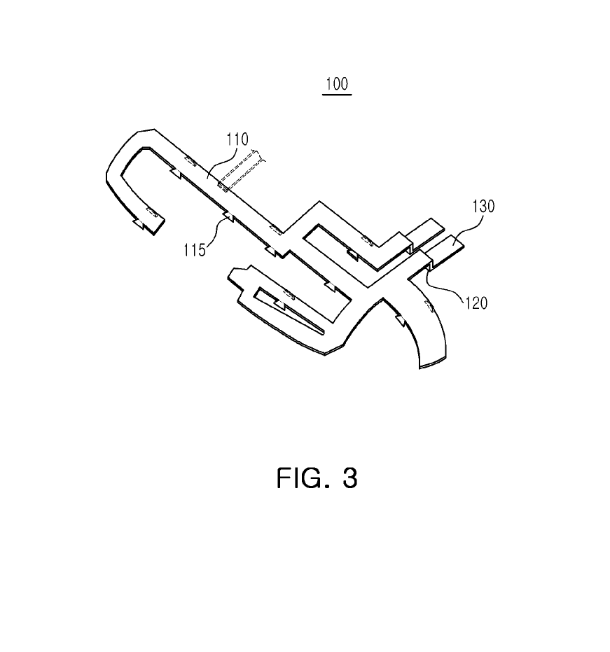

FIG. 3 is a schematic perspective view illustrating a radiator provided in the radiator frame according to the embodiment of the present invention.

The radiator frame 200 may be manufactured by injection-molding the radiator 100, and the radiator 100 provided in the radiator frame 200 may include the antenna pattern part 110 transmitting or receiving a signal and the connection terminal part 130 allowing the signal to be transmitted to and received from the circuit board 500 of the electronic device.

Referring to FIG. 3, the radiator 100 provided in the radiator frame 200 according to the embodiment of the present invention may include the antenna pattern part 110, the connection part 120, and the connection terminal part 130. In addition, the antenna pattern part 110 may include one or more spikes (fixed protrusion member protruding toward the radiator frame) 115 protruding toward the other surface along the edge thereof and molded in the molding frame 210. The spike 115 may prevent a radiator 100 from being separated from the radiator frame 200 in the case in which the radiator 100 is molded in and fixed to the radiator frame 200. One or more spikes 115 may be disposed along the edge of the antenna pattern part 110 so as to be spaced apart from each other by a predetermined interval.

The radiator 100 may be formed of a conductor such as aluminum, copper, or the like, to receive an external signal and transfer the external signal to a signal processing device of the electronic device such as the mobile communications terminal 400. In addition, the radiator 100 may include the antenna pattern part 110 forming a meander line in order to receive external signals in various bands.

The radiator 100 may include the antenna pattern part 110 receiving the external signal, the connection terminal part 130 contacting the circuit board 500 of the electronic device so as to transmit the external signal to the electronic device, and one or more spikes (fixed protrusion member protruding toward the radiator frame) 115 protruding toward the other surface along the edge of the antenna pattern part 110.

In addition, the radiator 100 may be formed in a three-dimensional structure by bending each of the antenna pattern part 110 and the connection terminal part 130, wherein the antenna pattern part 110 and the connection terminal part 130 may be connected to each other by the connection part 120. The connection part 120 may connect the antenna pattern part 110 and the connection terminal part 130 to each other so that the antenna pattern part 110 is formed on one surface of the molding frame 210 and the connection terminal part 130 is formed on the other surface of the molding frame 210.

The connection part 120 may allow the antenna pattern part 110 and the connection terminal part 130 to be formed on different planes and allow the connection terminal part 130 that is not embedded in the antenna pattern frame 300 to be exposed on a surface opposite to one surface on which the antenna pattern part 110 is formed.

Here, the connection terminal part 130 may allow the signal received from the antenna pattern part 110 to be transmitted to the circuit board 500 of the electronic device and elastically contact the terminal 510 of the circuit board 500 in order to secure reliability in transferring the signal.

Therefore, a component for securing elastic force may be added to the connection terminal part 130. That is, after the radiator frame 200 having the antenna pattern 110 embedded therein is injection-molded, external force may be applied to the connection terminal part 130 to thereby bend the connection terminal part 130 in order to give elasticity to the connection terminal part 130. In this case, a reinforcing part (not shown) such as a reinforcing emboss, or the like, is formed by compression from one surface to the other surface at the boundary between the connection part 120 and the connection terminal part 130, whereby elastic force of the connection terminal part 130 may be secured.

In addition, the boundary between the connection part 120 and the connection terminal part 130 may become more firm and damage to the connection terminal part 130 due to external impact may be prevented, by the reinforcing part (not shown).

Here, the reinforcing part (not shown) may be a reinforcing bid protruding at the boundary between the connection part 120 and the connection terminal part 130 or be formed in a round shape at the boundary between the connection part 120 and the connection terminal part 130.

However, the reinforcing part (not shown) is not limited to being the reinforcing bid or being formed in the round shape as described above, but may be any unit capable of securing elastic force of the connection terminal part 130 and preventing damage to the connection terminal part 130 due to external force.

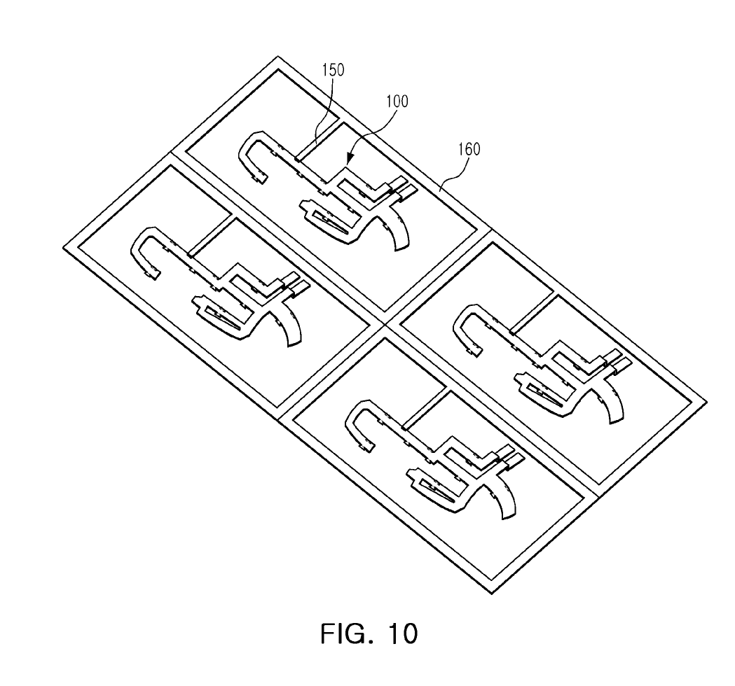

Meanwhile, in the embodiment of the present invention, one or more radiator frames 200 may be simultaneously manufactured using the array type (meaning the radiator type in which one or more antenna radiators 100 are put and molded in a mold, respectively, and are connected to each other, such that one or more radiator frames 200 in which the antenna radiator 100 is molded may be simultaneously manufactured by one process) of antenna radiator. To this end, each radiator 100 may be provided with the array frame 160 connected to each radiator and be injection-molded using the array-type radiator 180 connected to the array frame 160 by the frame connection part 150 extended from the end portion of the spike 115. A detailed description thereof will be provided below with reference to FIGS. 10 through 13.

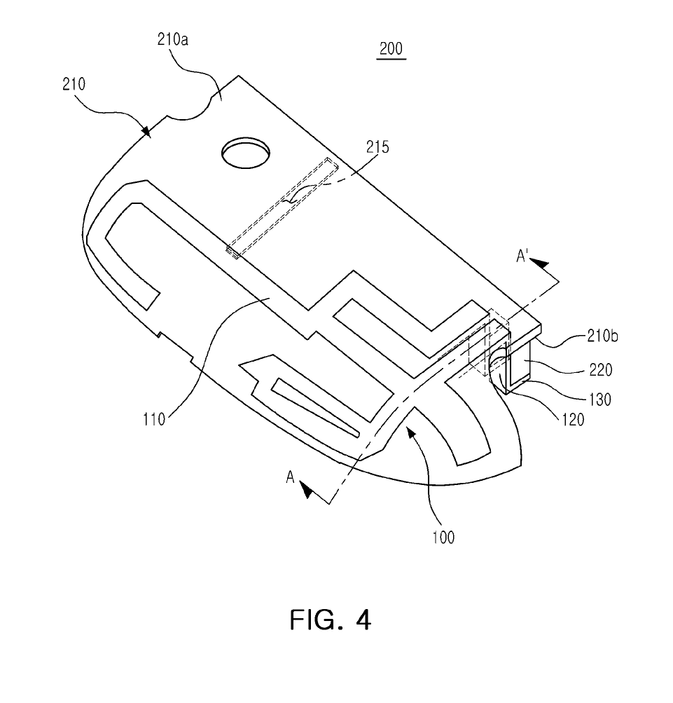

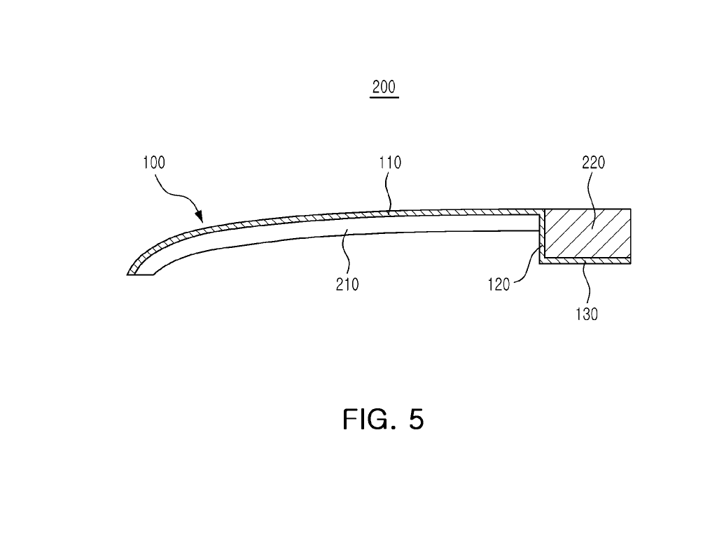

FIG. 4 is a schematic perspective view of the radiator frame according to the embodiment of the present invention; and FIG. 5 is a schematic cross-sectional view taken along line A-A′ of FIG. 4.

Referring to FIGS. 4 and 5, the radiator frame 200 according to the embodiment of the present invention may include the radiator 100 and the molding frame 210.

Here, since the configuration of the radiator 100 has been described above in detail, a description thereof will be omitted.

The molding frame 210 may be manufactured by injection-molding the radiator 100, and the connection terminal part 130 may have elasticity. That is, when the injection-molding of the radiator 100 is finished, the connection terminal part 130 may be rotated and bent so as to be spaced apart from the molding frame 210. In this case, since the radiator 100 is provided as an elastic body, the connection terminal part 130 may naturally have elasticity. Since other structures for reinforcing the elastic force have been described above in detail, a description thereof will be omitted.

The molding frame 210 may be an injection structure, the antenna pattern part 110 may be formed on one surface 210a of the molding frame 210, and the connection terminal part 130 may be formed on the other surface 210b of the molding frame 210, a surface opposite of one surface 210a.

In addition, the end portion of one or more spike 115 may be exposed on the other surface 210b of the molding frame 210, and the connection part trace groove 215 having a groove shape may be formed in the molding frame 210 from the exposed end portion of the spike 115 toward the edge of the molding frame 210.

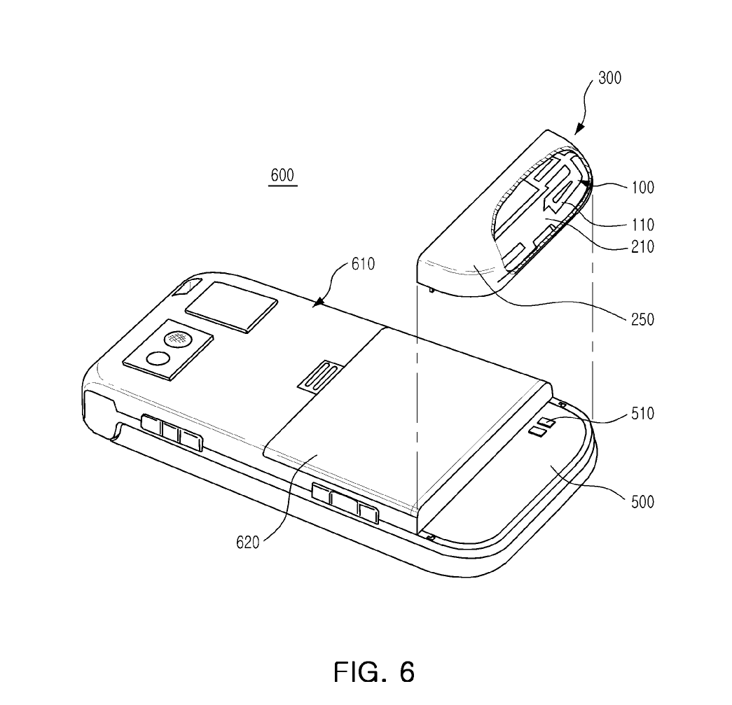

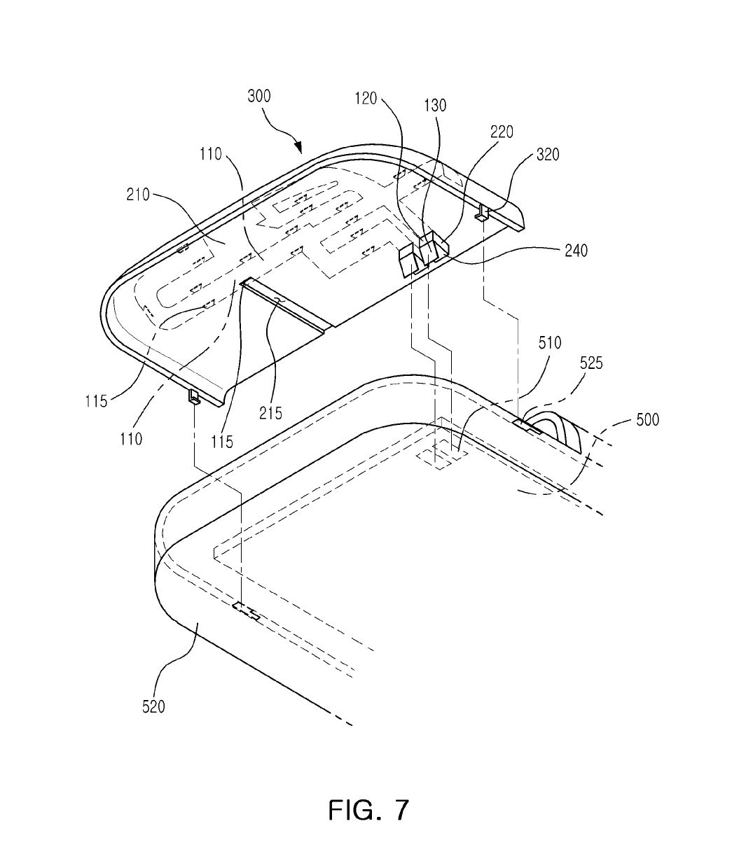

FIG. 6 is a schematic perspective view illustrating a shape in which an antenna pattern frame is coupled to a case of a mobile communications terminal, an electronic device according to another embodiment of the present invention, wherein the antenna pattern frame is shown in a form of a partially cut-away schematic perspective view; and FIG. 7 is a schematic exploded perspective view illustrating a form of a mobile communications terminal manufactured using the antenna pattern frame according to another embodiment of the present invention.

Referring to FIGS. 6 and 7, an antenna pattern frame 300 in which a radiator 100 including an antenna pattern part 110 is embedded may be mounted in a case 610 of a mobile communications terminal 600, an electronic device according to another embodiment of the present invention. That is, the mobile communications terminal 600, the electronic device according to another embodiment of the present invention, is different from the mobile communications terminal 400, the electronic device according to the embodiment of the present invention described with reference to FIGS. 1 through 5 in that the antenna pattern part 110 is injection-molded in a double-molding scheme including a primary molding process of injection-molding the antenna pattern part 110 to form a radiator frame 200 including a molding frame 210 and a secondary molding process of injection-molding the radiator frame 200 to form a cover frame 250. On the other hand, in the mobile communications terminal 400, the electronic device according to the embodiment of the present invention described with reference to FIGS. 1 through 5, the radiator frame 200 is mounted in the case of the electronic device in a structural scheme only through a primary molding process.

Although the mobile communications terminal 400, the electronic device according to the embodiment of the present invention, and the mobile communications terminal 600, the electronic device according to another embodiment of the present invention are different from each other in terms of a scheme, since they are the same as each other in that both of them include the radiator frame 200, a description thereof will be omitted and the same components will be denoted by the same reference numerals.

The antenna pattern frame 300 may be formed by embedding the antenna pattern part 110 between the molding frame 210 and the cover frame 250.

Here, the radiator 100 may be the same as the radiator 100 used in the electronic device 400 according to the embodiment of the present invention described with reference to FIGS. 1 through 5. The radiator 100 may include a connection terminal part 130 for connection to a terminal 510 of a circuit board 500, and the connection terminal part 130 is connected to the terminal 510 of the circuit board 500, whereby the antenna pattern frame 300 mounted in the case 610 of the electronic device may implement antenna performance in the mobile communications terminal 600.

Here, the connection terminal part 130 may elastically contact the terminal 510 in order to secure reliability of connection with the terminal 510.

In addition, at least one side of the antenna pattern frame 300 having an antenna pattern embedded therein may be provided with a coupling part 320 so as to be coupled to a main case 520 forming an exterior of the mobile communications terminal 600, the electronic device.

For example, the coupling part 320 protrudes from one side of the antenna pattern frame 300 having the antenna pattern embedded therein and the main case 500 includes a coupling line groove 525 corresponding to the coupling part 320, such that the coupling part 320 may be inserted and slid into the coupling line groove 525 to thereby be coupled to the coupling line groove 525. Alternatively, the protruding coupling part 320 is formed at the main case 520 and the coupling line groove 525 is formed in the case 300 of the electronic device having the antenna pattern embedded therein, such that the coupling part 320 may be slid into the coupling line groove 525 to thereby be coupled to the coupling line groove 525. However, a scheme in which the coupling part and the coupling line groove are coupled to each other is not limited thereto.

Since the antenna pattern 100 and a process of injection-molding the antenna pattern 100 to form the radiator frame 200 have been described above with reference to FIGS. 1 through 5, a detailed description thereof will be omitted.

Hereinafter, an antenna pattern frame having an antenna pattern embedded therein and a method of manufacturing the same will be described. That is, a process of injection-molding the antenna pattern part 110 in a double molding scheme in which a secondary molding process of injection-molding the radiator frame 200 to form the cover frame 250 is performed will be described.

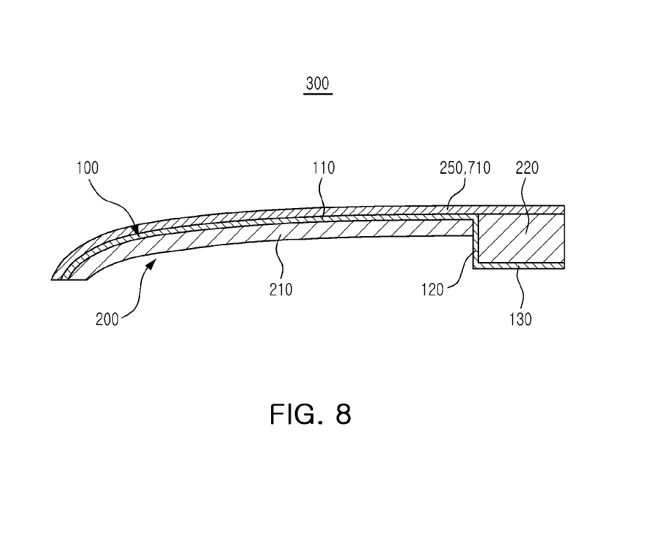

FIG. 8 is a schematic cross-sectional view of the antenna pattern frame having an antenna radiator embedded therein according to another embodiment of the present invention, taken along line A-A′ of FIG. 4.

Referring to FIG. 8, the antenna pattern frame 300 having the antenna pattern embedded therein may include a radiator frame 200 and a cover frame 250.

The cover frame 250 is provided as a separate injection product having a radiator receiving groove having a shape corresponding to that of the radiator frame 200 and the radiator frame 200 is adhered to the radiator receiving groove, whereby the antenna pattern frame 300 having the antenna pattern radiator embedded therein may be manufactured.

In addition, in the method of manufacturing an antenna pattern frame 300 having an antenna pattern radiator embedded therein according to the embodiment of the present invention, the antenna pattern frame 300 may be manufactured by disposing the radiator frame 200 in which the radiator 100 and the molding frame 210 are integrated with each other in an antenna pattern frame manufacturing mold having an internal space formed therein and introducing a resin material into the antenna pattern frame manufacturing mold to integrate the radiator frame 200 with the cover frame 250 formed by hardening the resin material. That is, the radiator frame 200 may be injection-molded to form the antenna pattern frame 300.

The antenna pattern frame 300 may be mounted in the electronic device such as the mobile communications terminal 400, or the like. In this case, an outer surface of the antenna pattern frame 300 may be additionally covered with a film, or the like. More specifically, an outer surface of the cover frame 250 exposed to the outside at the antenna pattern frame 300 may be additionally covered with a film, or the like. This is to consider an exterior design in the case in which the antenna pattern frame 300 is exposed to the outside. For example, the film may be immediately formed by spraying a liquid such as paint, or the like, or may be simply formed by attaching a manufactured good such as a film, a coating paper, or the like.

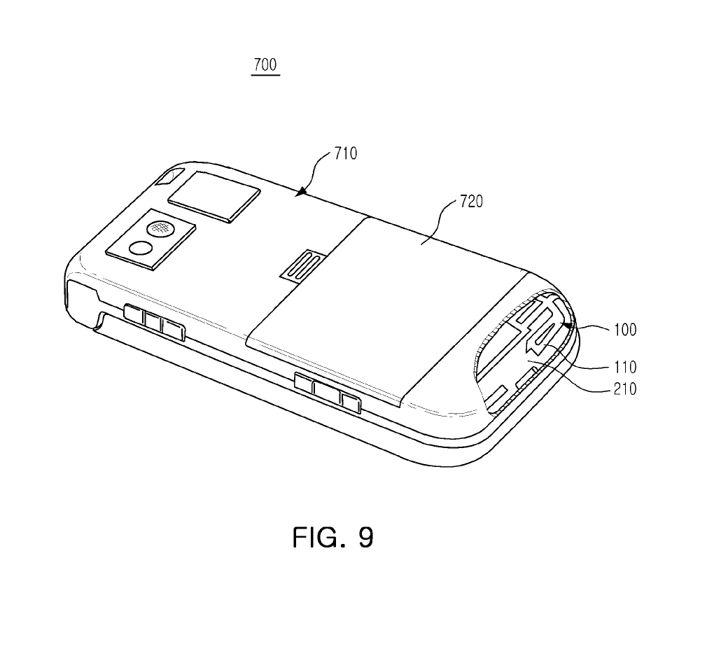

FIG. 9 is a schematic perspective view illustrating a state in which an antenna pattern frame is molded in a case of a mobile communications terminal, an electronic device according to another embodiment of the present invention, wherein the antenna pattern frame is shown in a form of a partially cut-away schematic perspective view of the case.

Referring to FIG. 9, an antenna pattern frame 300 in which a radiator 100 including an antenna pattern part 110 is embedded may be embedded in a case 710 of a mobile communications terminal 700, an electronic device according to another embodiment of the present invention.

That is, the mobile communications terminal 700, the electronic device according to another embodiment of the present invention, is the same as the mobile communications terminal 600, the electronic device according to another embodiment of the present invention described with reference to FIGS. 6 through 8 in that an antenna pattern part 110 is injection-molded in a double molding scheme, but is different from the mobile communications terminal 600, the electronic device according to another embodiment of the present invention described with reference to FIGS. 6 through 8 in that a primary molding process of injection-molding the antenna pattern part 110 to form a radiator frame 200 including a molding frame 210 and a secondary molding process of injection-molding the radiator frame 200 to form a case frame 710 are performed.

In other words, in the mobile communications terminal 600, the electronic device according to another embodiment of the present invention, a result of the secondary molding process is the cover frame 250; however, in the mobile communications terminal 700, the electronic device according to another embodiment of the present invention, a result of the secondary molding process is the case frame 710, that is, a case itself. The mobile communications terminal 700, the electronic device according to another embodiment of the present invention and the mobile communications terminal 600, the electronic device according to another embodiment of the present invention may have the same configuration as each other except for the above-mentioned configuration.

Therefore, as shown in FIG. 8, in the mobile communications terminal 600, the electronic device according to another embodiment of the present invention, a part additionally provided in a process of performing the secondary molding may be the case 710 itself.

FIGS. 10 through 13 are views illustrating a process of manufacturing a radiator frame using an antenna array according to the embodiment of the present invention.

First, FIG. 10 is a perspective view illustrating an array-type radiator 180. In the array-type radiator 180, each radiator 100 may be provided with an array frame 160 connected to each radiator and be connected to the array frame 160 by a frame connection part 150 extended from an end portion of a spike 115 provided in the radiator 100. In addition, a cut trace may be previously formed at a portion at which the spike 115 and the frame connection part 150 are connected to each other so that the frame connection part 150 is easily cut after injection-molding is finished. In addition, although the case in which the array-type radiator 180 includes four radiators 100 has been shown in FIG. 10, this is only an example. That is, an array-type radiator 180 including one or more radiators 100 may be used.

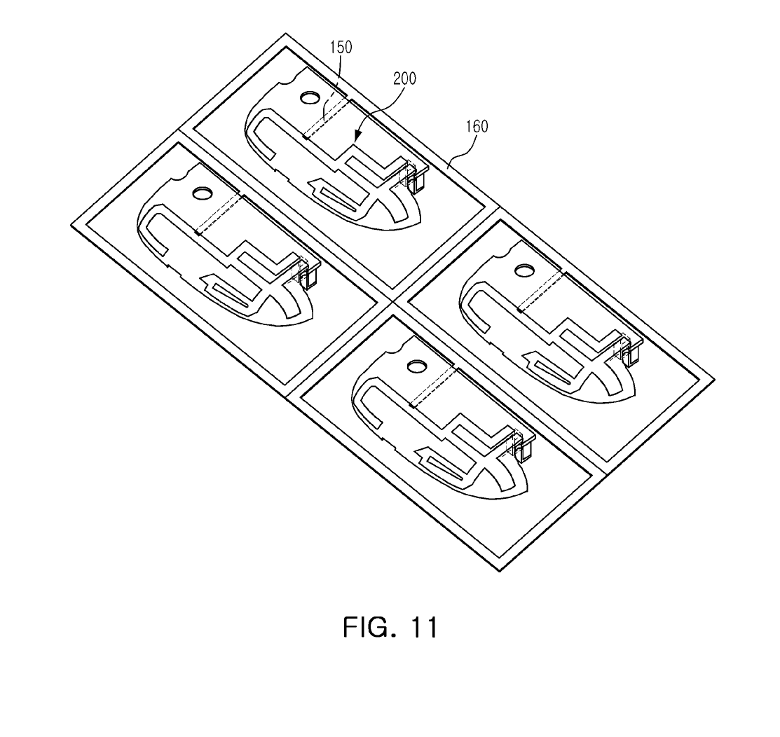

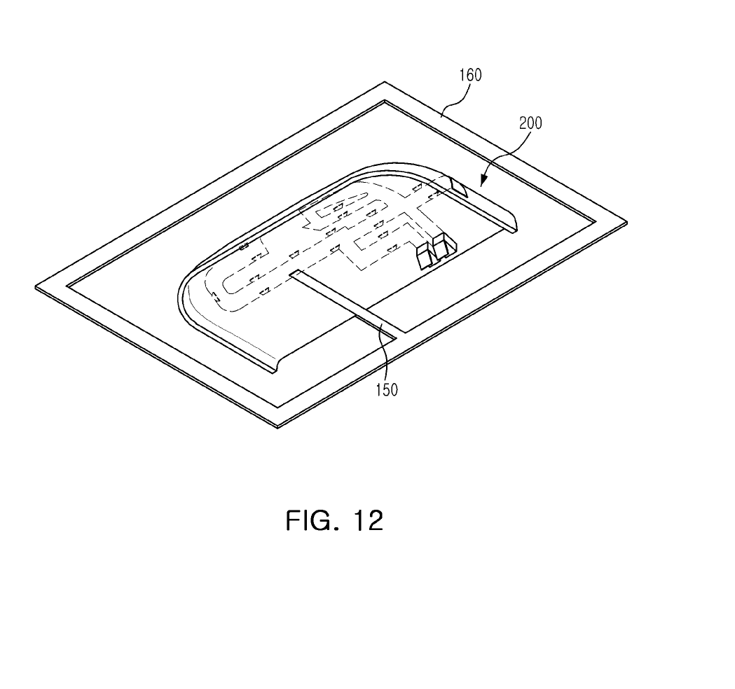

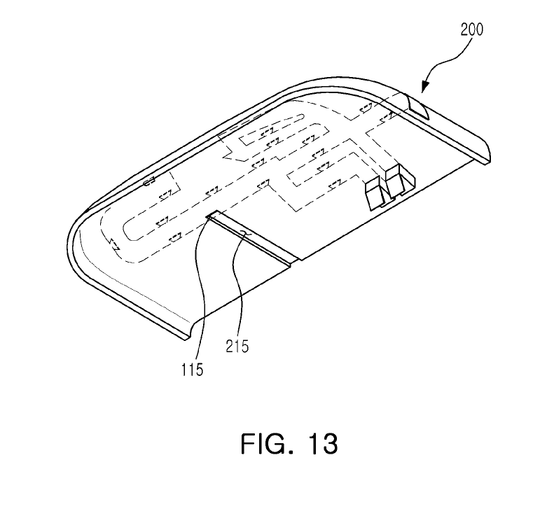

Next, FIGS. 11 and 12 are perspective views illustrating a form after the radiators 100 are injection-molded using molds that may be disposed in individual internal spaces, respectively, in the array-type radiator 180. As shown in FIG. 11, when the injection-molding is performed using the array-type radiator 180, even in the case in which the radiators 100 are disposed in the individual internal spaces, respectively, at least a portion of the frame connection parts 150 connecting the radiators 100 and the array frames 160 to each other may be disposed within the individual internal spaces to thereby be injection-molded together with the radiators 100. That is, the frame connection part 150 may be injection-molded to the other surface of the radiator frame 200, a result of injection-molding the radiator 100, that is, a surface opposite to a surface on which an antenna radiator 110 is exposed. Here, as shown in FIG. 12, when the frame connection parts 150 are removed, the radiator frame 200 as shown in FIG. 13 may be formed.

Finally, FIG. 13 is a perspective view illustrating a shape of the radiator frame 200 after performing the injection-molding using the array-type radiator 180, cutting a portion in which the spikes 115 and the frame connection parts 150 are connected to each other, and then removing the frame connection parts 150. When the frame connection part 150 is removed, the array frame 150 may also be removed together with the frame connection part 150. A surface opposite of the radiator frame 200 to one surface thereof on which the antenna radiator 110 is exposed may be provided with one or more connection part trace grooves 215 formed from end portions of the spikes 115 toward an edge of the molding frame 210.

As set forth above, according to the embodiments of the present invention, the molding frame in which a trace of a connection part is not generated on a surface may be provided. That is, a surface on which the molding frame is exposed to the outside may generally have a smooth shape in consideration of the fact that an exterior design of the molding frame is very important since the molding frame may be directly mounted in the electronic device.

While the present invention has been shown and described in connection with the embodiments, it will be apparent to those skilled in the art that modifications and variations can be made without departing from the spirit and scope of the invention as defined by the appended claims.

What is claimed is:

1. A radiator frame comprising:
a radiator including an antenna pattern part transmitting or receiving a signal and a connection terminal part electrically connecting the antenna pattern part and a circuit board to each other; and
a molding frame formed by injection-molding the radiator so that the antenna pattern part is exposed to one surface and the connection terminal part is exposed to the other surface, a surface opposite to the one surface,
wherein the antenna pattern part includes one or more spikes molded in and fixed to the molding frame, and
the molding frame includes one or more connection part trace grooves formed from end portions of one or more spikes toward an edge of the molding frame.

2. The radiator frame of claim 1, wherein one or more spikes are disposed along an edge of the antenna pattern part at predetermined intervals.

3. The radiator frame of claim 1, wherein the connection part trace groove is formed in the other surface of the molding frame.

4. The radiator frame of claim 1, wherein the end portion of one or more spike is exposed through the connection part trace groove toward the other surface of the molding frame.

5. An electronic device comprising:
an electronic device case;
the radiator frame of claim 1 mounted in the electronic device case; and
a circuit board electrically connected to the connection terminal part to receive the signal from the radiator or transmit the signal to the radiator.

6. An antenna pattern frame comprising:
a radiator frame including a radiator having an antenna pattern part transmitting or receiving a signal and a connection terminal part electrically connecting the antenna pattern part and a circuit board to each other and a molding frame formed by injection-molding the radiator so that the antenna pattern part is exposed to one surface and the connection terminal part is exposed to the other surface, a surface opposite to the one surface; and
a cover frame injection-molded so as to cover one surface of the radiator frame to allow the antenna pattern part to be embedded between the cover frame and the radiator frame,
wherein the antenna pattern part includes one or more spikes molded in and fixed to the molding frame, and
the molding frame includes one or more connection part trace grooves formed from end portions of one or more spikes toward an edge of the molding frame.

7. The antenna pattern frame of claim 6, wherein one or more spikes are disposed along an edge of the antenna pattern part at predetermined intervals.

8. The antenna pattern frame of claim 6, wherein the connection part trace groove is formed in the other surface of the molding frame.

9. An electronic device comprising:
an electronic device case;
the antenna pattern frame of claim 6 mounted in the electronic device case; and
a circuit board electrically connected to the connection terminal part to receive the signal from the radiator or transmit the signal to the radiator.

10. An electronic device case comprising:
a radiator frame including a radiator having an antenna pattern part transmitting or receiving a signal and a connection terminal part electrically connecting the antenna pattern part and a circuit board to each other and a molding frame formed by injection-molding the radiator so that the antenna pattern part is exposed to one surface and the connection terminal part is exposed to the other surface, a surface opposite to the one surface; and
a case frame injection-molded so as to cover one surface of the radiator frame to allow the antenna pattern part to be embedded between the cover frame and the radiator frame and forming an exterior of an electronic device,
wherein the antenna pattern part includes one or more spikes molded in and fixed to the molding frame, and
the molding frame includes one or more connection part trace grooves formed from end portions of one or more spikes toward an edge of the molding frame.

11. An electronic device comprising:
the electronic device case of claim 10;
a circuit board electrically connected to the connection terminal part to receive the signal from the radiator or transmit the signal to the radiator.
